(19) United States
(12) Patent Application Publication
(10) Pub. No.: US 2016/0283052 A1
(43) Pub. Date: Sep. 29, 2016

(54) METHOD, SYSTEM AND RECORDING MEDIUM FOR SORTING OBJECTS IN A MESSENGER PLATFORM

(71) Applicant: LINE Corporation, Tokyo (JP)

(72) Inventor: Hyun Joo SEO, Seongnam-si (KR)

(21) Appl. No.: 14/838,893

(22) Filed: Aug. 28, 2015

(30) Foreign Application Priority Data
Mar. 25, 2015 (KR) 10-2015-0041839
Apr. 30, 2015 (KR) 10-2015-0061449

(51) Int. Cl. G06F 3/0482; H04L 12/58

(52) U.S. Cl. CPC G06F 3/0482; H04L 51/04; H04L 51/32; H04L 51/16

(57) ABSTRACT

In one example embodiment, an object sorting method implemented with a computer, includes displaying, by a processor, a list in which a plurality of objects are sorted according to a sorting reference, while an application associated with the plurality of objects is in use and identifying, by the processor, at least one unconfirmed object from among the plurality of objects, the at least one unconfirmed object including information unconfirmed by a user of the application. The method further includes first adjusting, by the processor, the list such that the at least one unconfirmed object is displayed at a top of the list, recognizing, by the processor, confirmation of the at least one unconfirmed object based on a control signal, and second adjusting, by the processor, the list based on the sorting reference after the at least one unconfirmed object is confirmed.

### CROSS-REFERENCE TO RELATED APPLICATIONS

A claim for priority under 35 U.S.C. §119 is made to Korean Patent Application No. 10-2015-0041839 filed Mar. 25, 2015, and Korean Patent Application No. 10-2015-0061449 filed Apr. 30, 2015, in the Korean Intellectual Property Office, the entire contents of each of which is hereby incorporated by reference.

### BACKGROUND

1. Field

Embodiments of the inventive concepts described herein relate to methods, systems and/or recording medium for sorting an object displayed in driving an application.

2. Description of the Related Art

An instant messenger as a conventional communication tool may be software executed by a processor that sends and receives messages and data in real time and may allow a user to register a chat counterpart (e.g., another user) on a messenger and to send and receive messages with the counterpart in real time.

Such instant messenger may be widely used at a mobile environment of a mobile communication terminal as well as at a personal computer. For example, disclosed in the Korean Patent Publication No. 2002-0074304 are mobile messenger service system and method for a mobile terminal using a wireless communication network to allow a messenger service to be provided among mobile messengers installed on mobile terminals.

### SUMMARY

Example embodiments of inventive concepts provide object sorting method, system and/or a record medium, capable of providing a separate function for sorting unconfirmed objects of objects displayed in a running application.

Furthermore, example embodiments of inventive concepts provide object sorting method, system and/or the recording medium, capable of retaining a previous sorting reference when an unconfirmed object is confirmed after unconfirmed objects are sorted by a control of the user or when an application's use has resumed after a period of inactivity.

Also, example embodiments of inventive concepts provide object sorting method, system and/or the recording medium, capable of confirming unconfirmed objects of a list without executing the unconfirmed object.

In one example embodiment, an object sorting method implemented with a computer, includes displaying, by a processor, a list in which a plurality of objects are sorted according to a sorting reference, while an application associated with the plurality of objects is in use and identifying, by the processor, at least one unconfirmed object from among the plurality of objects, the at least one unconfirmed object including information unconfirmed by a user of the application. The method further includes first adjusting, by the processor, the list such that the at least one unconfirmed object is displayed at a top of the list, recognizing, by the processor, confirmation of the at least one unconfirmed object based on a control signal, and second adjusting, by the processor, the list based on the sorting reference after the at least one unconfirmed object is confirmed.

In yet another example embodiment, each of the plurality of objects is associated with a target with which the user communicates via the application.

In yet another example embodiment, the application is an instant messenger application, and each of the plurality of objects is associated with one or more of a plurality of targets, the instant messenger including a chat room list in which one or more of the plurality of targets with which the user communicates are listed.

In yet another example embodiment, the identifying of the at least one unconfirmed object identifies one or more chat rooms of the chat room list having a message, unconfirmed by the user, from among messages received at the application, as the at least one unconfirmed object.

In yet another example embodiment, the identifying of the at least one unconfirmed object identifies one or more chat rooms of the chat room list having a message, unconfirmed by a corresponding one of the plurality of targets, from among messages transmitted to the plurality of targets via the application, as the at least one unconfirmed object.

In yet another example embodiment, when the identifying identifies at least two unconfirmed objects, the first adjusting the list includes applying the sorting reference to the at least two unconfirmed objects at the top of the list to rearrange the at least two unconfirmed objects.

In yet another example embodiment, when the identifying identifies at least two unconfirmed objects, the first adjusting the list includes applying a reference different from the sorting reference to the at least two unconfirmed objects at the top of the list to rearrange the at least two unconfirmed objects.

In yet another example embodiment, the first adjusting the list includes rearranging the at least one unconfirmed object using one of a message reception/transmission time, a number of messages associated with each of the at least one unconfirmed object, a name of a chat room associated with the at least one unconfirmed object, a name of a target associated with the at least one unconfirmed object, whether or not the target belongs to a list of favorite targets in the application, and a number of times that a message is exchanged with the target in the at least one unconfirmed object.

In yet another example embodiment, the recognizing the confirmation of the at least one unconfirmed object includes recognizing that information associated with the at least one unconfirmed object is read, when the at least one unconfirmed object is executed on the application.

In yet another example embodiment, the recognizing the confirmation of the at least one unconfirmed object includes receiving the control signal, the control signal being a confirmation request signal for the at least one unconfirmed object.

In one example embodiment, a non-transitory computer-readable medium storing instructions, which when executed by a processor, cause the processor to provide an instant messaging service by displaying a list in which a plurality of objects are sorted according to a sorting reference, while an application associated with the plurality of objects is in use, identifying at least one unconfirmed object from among the plurality of objects, the at least one unconfirmed object including information unconfirmed by a user of the application, first adjusting the list such that the at least one unconfirmed object is displayed at a top of the list, recognizing confirmation of the at least one unconfirmed object based on a control signal, and second adjusting the list based on the sorting reference after the at least one unconfirmed object is confirmed.

In one example embodiment, an object sorting system includes a processor. The processor is configured to execute computer-readable instructions to display a list in which a plurality of objects are sorted according to a sorting reference, while an application associated with the plurality of objects is in use, identify at least one unconfirmed object from among the plurality of objects, the at least one unconfirmed object including information unconfirmed by a user of the application, first adjust the list such that the at least one unconfirmed object is displayed at a top of the list, recognize confirmation of the at least one unconfirmed object based on a control signal, and second adjust the list based on the sorting reference after the at least one unconfirmed object is confirmed.

In yet another example embodiment, each of the plurality of objects is associated with a target with which the user communicates via the application.

In yet another example embodiment, the application is an instant messenger application, and each of the plurality of objects is associated with one or more of a plurality of targets, the instant messenger including a chat room list in which one or more of the plurality of targets with which the user communicates are listed.

In yet another example embodiment, the processor is configured to identify the at least one unconfirmed object by identifying one or more chat rooms of the chat room list having a message, unconfirmed by the user, from among messages received at the application, as the at least one unconfirmed object.

In yet another example embodiment, the processor is configured to identify the at least one unconfirmed object by identifying one or more chat rooms of the chat room list having a message, unconfirmed by a corresponding one of the plurality of targets, from among messages transmitted to the plurality of targets via the application, as the at least one unconfirmed object.

In yet another example embodiment, when the processor identifies at least two unconfirmed objects, the processor is configured to first adjust the list by applying the sorting reference to the at least two unconfirmed objects at the top of the list to rearrange the at least two unconfirmed objects.

In yet another example embodiment, when the processor identifies at least two unconfirmed objects, the processor is configured to first adjust the list by applying a reference different from the sorting reference to the at least two unconfirmed objects at the top of the list to rearrange the at least two unconfirmed objects.

In yet another example embodiment, the processor is configured to recognize the confirmation of the at least one unconfirmed object by recognizing that information associated with the at least one unconfirmed object is confirmed, when the at least one unconfirmed object is executed on the application.

In yet another example embodiment, the processor is configured to recognize the confirmation of the at least one unconfirmed object by receiving the control signal, the control signal being a confirmation request signal for the at least one unconfirmed object

### BRIEF DESCRIPTION OF THE FIGS

The above and other objects and features will become apparent from the following description with reference to the following figures, wherein like reference numerals refer to like parts throughout the various figures unless otherwise specified, and wherein

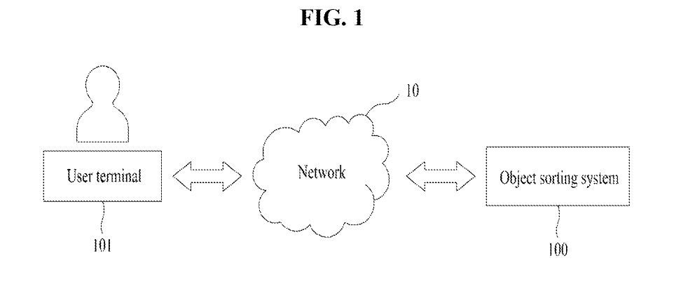

FIG. 1 is a diagram illustrating an object sorting environment according to an example embodiment;

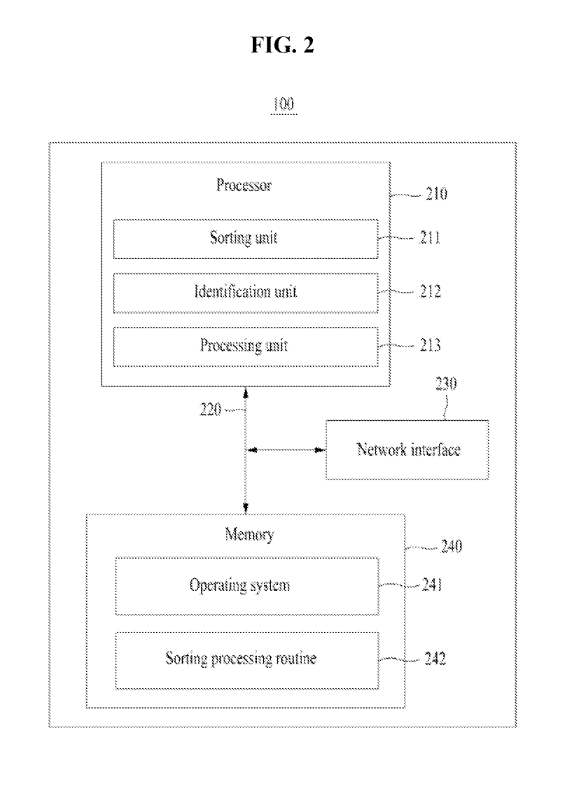

FIG. 2 is a block diagram illustrating an internal configuration of an object sorting system according to an example embodiment;

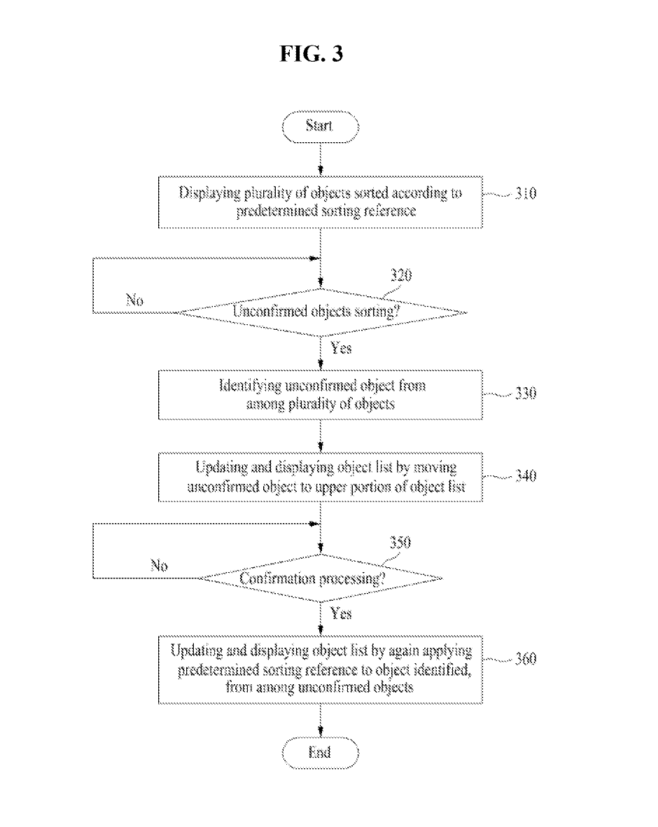

FIG. 3 is a flow chart illustrating an object sorting method according to an example embodiment;

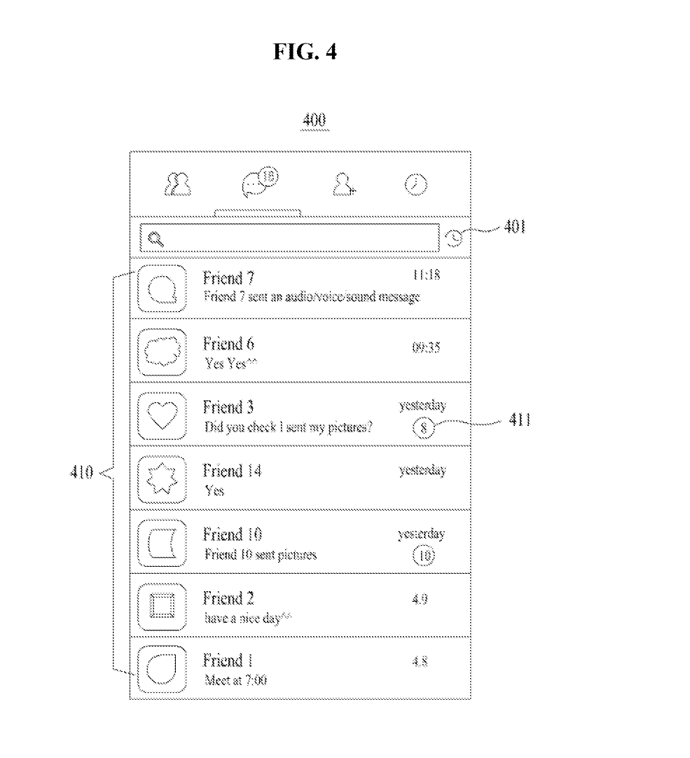

FIGS. 4 to 9 illustrate user interface screens associated with an object sorting procedure, according to an example embodiment; and

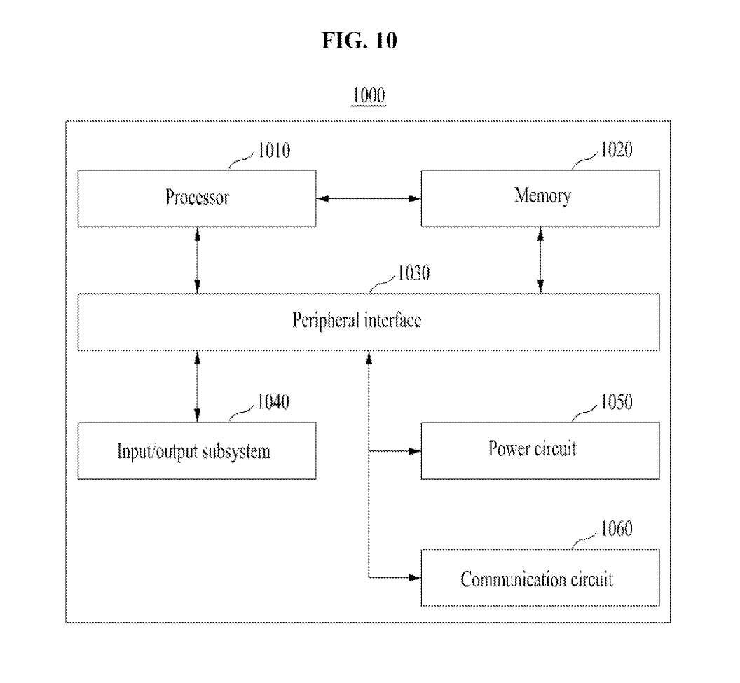

FIG. 10 is a block diagram illustrating an internal configuration of a computer system according to an example embodiment.

### DETAILED DESCRIPTION OF EXAMPLE EMBODIMENTS

Example embodiments will be described in detail with reference to the accompanying drawings. Inventive concepts, however, may be embodied in various different forms, and should not be construed as being limited only to the illustrated embodiments. Rather, these example embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

In the description below, it will be understood that when an element such as a layer, region, substrate, plate, or member is referred to as being “on” another element, it can be directly on the other element or intervening elements may be present. In contrast, the term “directly” means that there are no intervening elements.

Below, example embodiments of inventive concepts may be described in detail with reference to accompanying drawings.

The example embodiments may relate to technologies for sorting an object to be displayed in a running application, and in detail, to object sorting method and system and a recording medium, capable of providing a separate function for sorting unconfirmed objects of an object list.

In this specification, an “object” may be an action target of an application such as a messenger, an e-mail, a message (e.g., SMS, MMS, etc.), a phone book, a social network service (SNS) and the like, and may be understood as including all targets to which notification is provided based on data reception/transmission, a status change, or the like. For example, a target formed of a chat room list or a friend list on a messenger, a reception or transmission mail list on an e-mail, a reception or transmission message list on a message, a recent call record on a phone book, a recent notification list on a SNS, the like may correspond to an object.

FIG. 1 is a diagram illustrating an object sorting environment according to an example embodiment. In FIG. 1, a user terminal 101 and an object sorting system 100 are illustrated. Arrows in FIG. 1 mean that data is transmitted and received using a wired and/or wireless network 10.

The user terminal 101 may execute one or more processes to perform one or more functions described herein. The user terminal 101 may include all terminal apparatuses that connect to a web/mobile site associated with the object sorting system 100 or install or execute a service-dedicated application. In this case, the user terminal 100 may perform an overall operation of a service including service screen construction, data input, data communication, data storage, and the like, under a control of the web/mobile site or the service-dedicated applications.

The user terminal 102 may include, for example, a personal computer (PC), a note computer, a laptop computer, a smart phone, a tablet, or a wearable computer. However, the scope and spirit of inventive concepts is not limited thereto.

The user terminal 101 may be coupled to a network 10 (e.g., an internet, a local area network, or the like) directly or indirectly. For example, the personal computer and the notebook computer may be directly coupled to the network 10 through a wired network connection. The laptop computer may be wirelessly coupled to the network through a wireless communication channel established between the laptop computer and a wireless access point (WAP). The smart phone may be wirelessly coupled to the network 10 through a wireless communication channel established between the smart phone and a cellular network/bridge. In this case, the network 10 may communicate with one or more secondary networks. The secondary networks may include, for example, a local area network, a wide area network, or an intranet. However, the scope and spirit of inventive concepts may not be limited thereto.

The user terminal 101 may interface with the object sorting system 100 through the network 10 described above.

The object sorting system 100 may execute one or more processes to perform one or more functions described herein. Specifically, the object sorting system 100 may provide a function for sorting an object list related to an application driven on the user terminal and may further provide a separate function for rearranging unconfirmed objects in the object list.

The object sorting system 100 may correspond to a server. The server may include, for example, a server computing device, a personal computer, a series of servers, a mini computer, and/or a main frame computer. However, the scope and spirit of inventive concepts is not limited thereto. For example, the server computer may be a distributed system, and operations of the server computer may be executed simultaneously and/or sequentially on one or more processors.

The object sorting system 100 may be implemented on the user terminal 101 in an application form. However, the scope and spirit of inventive concepts is not limited thereto. For example, in a client-server environment, the object sorting system 100 may be implemented so as to be included in a platform to provide an object sorting function.

The object sorting system 100 may be described as interfacing with the user terminal 101 through the network 10. However, the scope and spirit of inventive concepts is not limited thereto. The object sorting system 100 may be implemented on the user terminal 101 in the application form and may provide the object sorting function in a local environment.

FIG. 2 is a block diagram illustrating an internal configuration of an object sorting system according to an example embodiment. FIG. 3 is a flow chart illustrating an object sorting method according to an example embodiment.

As illustrated in FIG. 2, an object sorting system 100 according to an example embodiment of inventive concepts may include a processor 210, a bus 220, a network interface 230, and a memory 240. The memory 240 may include an operating system 241 and a sorting processing routine 242. The processor 210 may include a sorting unit 211, an identification unit 212, and a processing unit 213. In other example embodiments, the object sorting system 100 may include components of which the number is more than that of components illustrated in FIG. 2.

The memory 240 which is a computer-readable recording medium may include a random access memory (RAM), a read only memory (ROM), and a permanent mass storage device such as a disk drive. In addition, program code for the operating system 241 and the service routine 242 may be stored in the memory 240. These software components may be loaded from a separate computer-readable recording medium independent of a memory 240, using a drive mechanism (not illustrated). The separate computer-readable recording medium may include a recording medium such as a floppy drive, a disk, a tape, a DVD/CD-ROM drive, a memory card, and the like. In other embodiment, software components may be loaded to the memory 240 through the network interface 230, not the computer-readable recording medium.

The bus 220 may enable communications and a data transfer between components of the object sorting system 200. The bus 200 may be implemented using a high-speed serial bus, a parallel bus, a storage area network (SAN), and/or other communication technology.

The network interface 230 may be a computer hardware component for coupling the object sorting system 200 to the computer network. The network interface 230 may connect the object sorting system 200 to the computer network through wireless and/or wired connections.

The processor 210 may process an instruction of a computer program by performing a basic arithmetic operation, a logic operation, and an input/output operation of the object sorting system 200. The instruction may be provided to the processor 210 through the bus 220 and by the memory 240 or the network interface 230. The processor 210 may execute one or more computer-readable programs and be configured to include the sorting unit 211, the identification unit 212 and the processing unit 213. The computer-readable programs may be stored in a recording device such as the memory 240.

The sorting unit 211, the identification unit 212 and the processing unit 213 may be implemented to perform steps 310 to 360 of an object sorting method which will be described below with reference to FIG. 3.

In step 310, during an execution of an application such as the example messenger described above, the sorting unit 211 may sort and display an object list including a plurality of objects displayed on an execution screen of the application, based on a predetermined (and/or alternatively, desired) sorting reference. For example, when an object list is a chat room list of a messenger, chat rooms may be sorted and displayed in a descending order, based on a basic sorting reference being a time when a message is sent or received in a chat room. At this time, a screen on which the object list is displayed may include an “unconfirmed object sorting” menu as a separate sorting function for sorting unconfirmed objects of the object list.

In steps 320 and 330, when the “unconfirmed object sorting” menu is controlled by a user of the application, the identification unit 212 may identify an unconfirmed object, having information unconfirmed by the user, from among a plurality of objects included in the object list. For example, the identification unit 212 may identify, as an unconfirmed object, a chat room having a message, unconfirmed by the user, from among messages received from a counterpart of the chat room with respect to a chat room list of a messenger. As another example of the unconfirmed object, the identification unit 212 may also identify, as the unconfirmed object, a chat room having a message, unconfirmed by the counterpart, from among messages which the user transmits to the counterpart through the chat room.

In step 340, the sorting unit 211 may update and display the object list by moving an unconfirmed object, identified in controlling the “unconfirmed object sorting” menu, to an upper portion of the object list. In this case, a predetermined (and/or alternatively, desired) sorting reference of the object list may be applied to sort unconfirmed objects, or a sorting reference variable according to a type or characteristic of an application may be applied to sort unconfirmed objects. For example, the sorting unit 211 may locate a chat room (hereinafter referred to as an “unconfirmed chat room”), including a message unconfirmed by a user and/or a counterpart, of a chat room list of a messenger at a top portion of the chat room list. At this time, when the unconfirmed chat room is in plurality, the sorting unit 211 may sort the unconfirmed chat rooms based on message reception/transmission times of the unconfirmed chat rooms. In another example, when the unconfirmed chat room is in plurality, the sorting unit 211 may sort the unconfirmed chat rooms based on one of a variety of references such as the number of unconfirmed messages, whether or not a sender of any of the unconfirmed messages belongs to a favorite counterpart list (e.g., favorite friend list) on the user terminal 101, a name of the counterpart, a name of the chat room, and the number of events that a message is sent and received to or from the counterpart, and the like.

In step 350, the processing unit 213 may recognize confirmation processing on the unconfirmed object based on a control signal from the user of the application. For example, the case that the user executes the unconfirmed object (e.g., reads the unread messages sent by a particular chat counterpart) may be processed by the processing unit 213 as the user identifies unconfirmed information from the object. As another example, an “auto-confirmation processing” menu may be provided on a screen where the object list is displayed through the “unconfirmed object sorting” menu, as a separate function for confirming unconfirmed objects; when the ‘auto-identification sorting menu is controlled with respect to an unconfirmed object, even though the user does not directly identify the unconfirmed information of a corresponding object. Accordingly, the unconfirmed information may be forcibly processed by the processing unit 213 as being identified from the object list.

In step 360, the sorting unit 211 may update and display the object list by again applying the predetermined (and/or alternatively, desired) sorting reference to an object, identified from among unconfirmed objects. In other words, when the confirmation processing on an unconfirmed object is recognized according to a control signal of the user, the sorting unit 211 may again arrange and display a chat room on the identified object in a descending order based on a basic sorting reference. Furthermore, a previous initial list may be maintained by applying a predetermined (and/or alternatively, desired) sorting reference to an object list when under a control of an application user, a screen where the object list is displayed is switched into a screen not associated with the object list and is then returned or when an application is terminated and is again used.

Below, detailed example embodiments in each of which a chat room of a messenger is used as a representative example of an object will be described.

FIGS. 4 to 9 are diagrams schematically illustrating service pages displayed on a user terminal as a user interface associated with an object sorting procedure of a sorting unit 211.

FIG. 4 illustrates a chat room list screen of a messenger, according to an example embodiment. As illustrated in FIG. 4, the chat room list screen 400 may include a chat room list 410 in which chat rooms for exchanging messages with counterparts are arranged as objects corresponding to action targets of a messenger. At this case, chat rooms of the chat room list 410 may be arranged (or sorted) in descending order based on message reception/transmission times. Notification information 411 on a received message of each chat room may be displayed on the chat room list screen 400, and at this time, the notification information 411 may include the number of unconfirmed messages by providing notification on a message, unconfirmed by a user, from among received messages.

Moreover, the chat room list screen 400 may include an “unconfirmed object sorting” menu 401 for separately sorting unconfirmed chat rooms of the chat room list. Unconfirmed chat rooms of the chat room list 410 may be collectively displayed when the “unconfirmed object sorting” menu is controlled by a user.

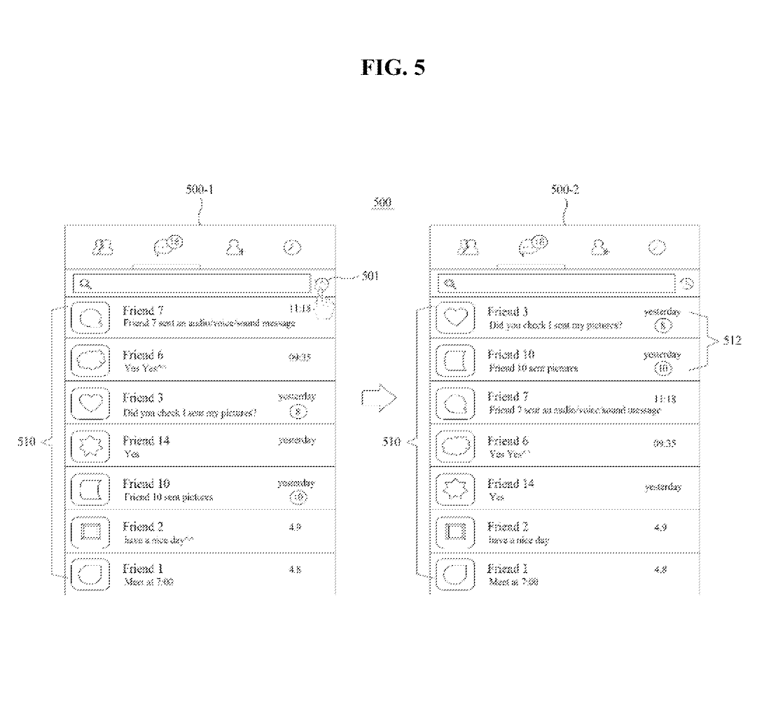

FIG. 5 illustrates chat room list screens of a messenger, according to an example embodiment Referring to FIG. 5, when an “unconfirmed object sorting” menu 501 of a chat room list screen 500 is controlled (e.g., activated by a user through a click for example), as shown in screen 500-1, unconfirmed chat rooms 512, each including at least one message unconfirmed by a user, from among unconfirmed chat rooms of a chat room list 510 may be located and displayed at a top portion of the chat rooms 512, as shown in screen 500-2. At this time, a sorting order between unconfirmed chat rooms may be determined according to one of a variety of references such as a message reception time, the number of unconfirmed messages, whether or not a sender of the any of the unconfirmed messages belongs to a favorite counterpart list (e.g., favorite friend list) on the user terminal 101, a name of the counterpart, a name of the chat room, and the number of events that a message is exchanged with a counterpart, and the like.

Therefore, as a user checks unconfirmed chat rooms 512 displayed on a top portion of the chat room list 510 using the “unconfirmed object sorting” menu 501, the unconfirmed chat rooms 512 may be gradually pushed back with the lapse of time, thereby preventing a user from missing checking of a received message.

Afterwards, if the unconfirmed chat rooms 512 are recognized as being checked, the sorting unit 211 may update and display the chat room list by again applying the predetermined (and/or alternatively, desired) sorting reference to a checked object.

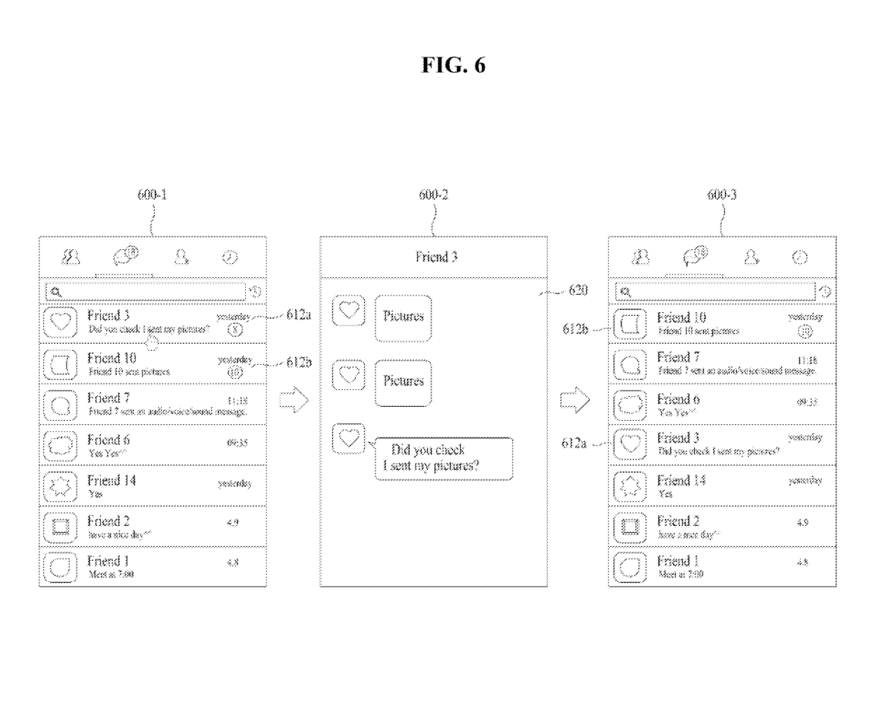

FIG. 6 illustrates chat room list screens of a messenger, according to an example embodiment. As illustrated in FIG. 6 and the screen 600-1, if a user selects a “friend 3” chat room 612a under the condition that the “friend 3” chat room 612a and a “friend 10” chat room 612b are displayed at a top portion of a list as unconfirmed chat rooms, a conversation screen 620 for exchanging a message with “friend 3” may be displayed, and the user may check one or more unconfirmed messages associated with “friend 3”, which is shown in screen 600-2. If a user closes the conversation screen 620, a predetermined (and/or alternatively, desired) sorting reference may be applied to the “friend 3” chat room 612a so as to be returned to an original position, as shown in screen 600-3. The “friend 10” chat room 612b including an unconfirmed message may remain at and be displayed at a top portion of the messenger list, as shown in screen 600-3.

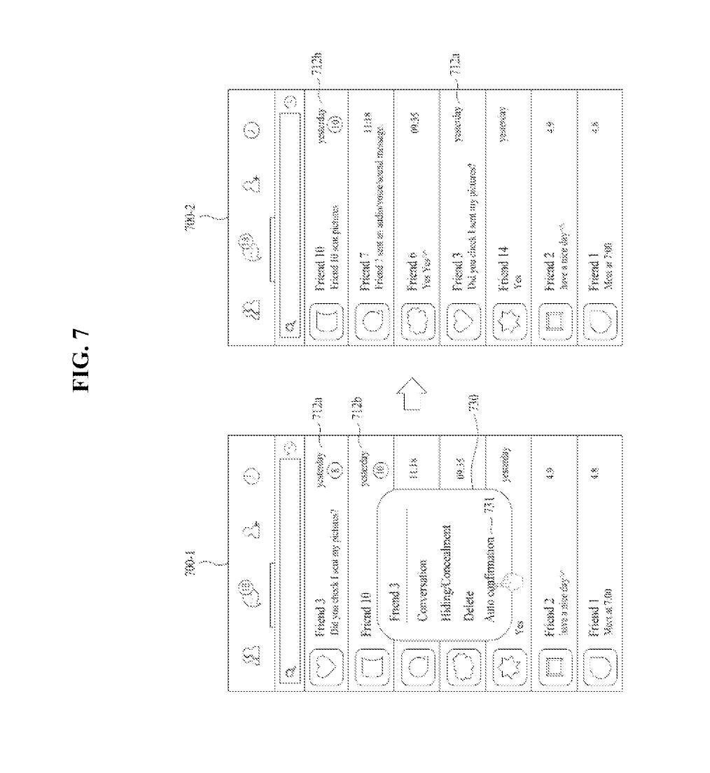

FIG. 7 illustrates chat room list screens of a messenger, according to an example embodiment. As illustrated in screen 700-1 of FIG. 7, a chat room menu screen 730 may be displayed if a user selects a “friend 3” chat room 712a under the condition that the “friend 3” chat room 712a and a “friend 10” chat room 712b as unconfirmed chat rooms are displayed at a top portion of a list. Here, the chat room menu screen 730 may include an “auto confirmation processing” menu 731 for confirmation processing on unconfirmed messages. When selecting the “auto confirmation processing” menu 731 of the chat room menu screen 730 on the “friend 3” chat room 712a, the user may perform confirmation processing on all unconfirmed messages on the “friend 3” chat room 712a in the chat room list without entering into the chat screen. When the user selects the “auto confirmation processing” menu 731, the ‘friend 3’ chat room 712a may be returned to the original position by applying the predetermined (and/or alternatively desired) sorting reference to the ‘friend 3’ chat room 712a, and the ‘friend 10’ chat room 712b having an unconfirmed message may be displayed at the top portion of the list, as shown in screen 700-2.

Furthermore, the messenger may sort and display friends including messages, which are not read, with respect to a friend list as well as a chat room list.

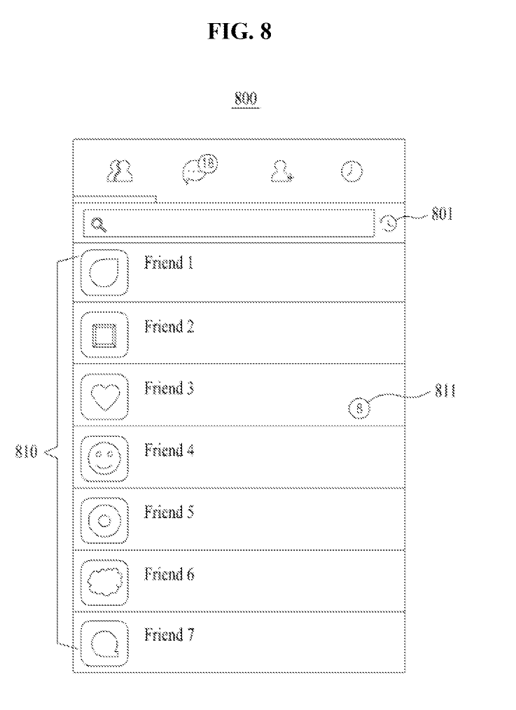

FIG. 8 illustrates a friend list screen of a messenger, according to an example embodiment. As illustrated in FIG. 7, the friend list screen 800 may include a whole friend list 810 in which friends with which messages are exchanged are arranged. The whole friend list 810 may be sorted in a descending order based on registered names. Notification information 811 on received messages of respective friends may be displayed at the friend list screen 800. The notification information 811 may include the number of unconfirmed messages by providing notification on a message, not checked by a user, from among received messages. Similarly, the friend list screen 800 may include an “unconfirmed object sorting” menu 801 for separately sorting friends, having unconfirmed messages, from among friends of the whole friend list 810.

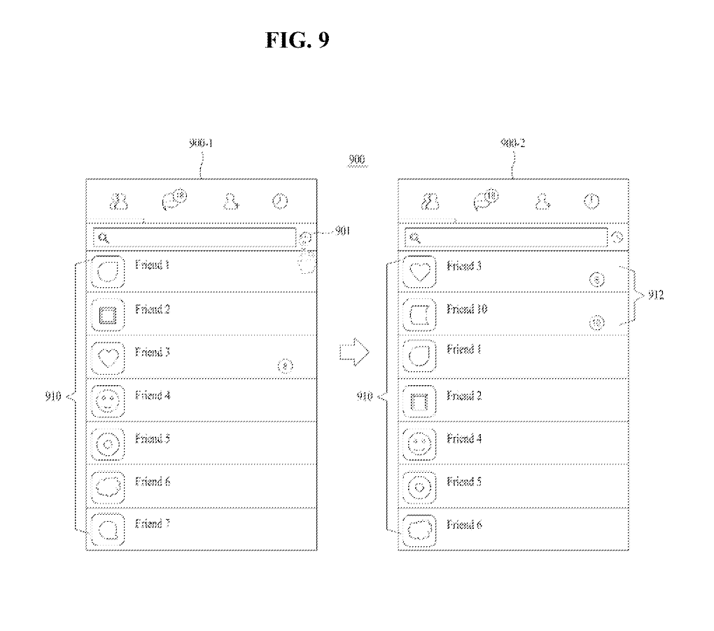

FIG. 9 illustrates chat room list screens of a messenger, according to an example embodiment. Referring to screen 900-1 of FIG. 9, when an “unconfirmed object sorting” menu 901 of a friend list screen is controlled, a friend list 912 having messages not checked by a user may be located and displayed at a top portion of the whole friend list 910. Here, a sorting order between the friend lists having unconfirmed messages may be determined according to one of a variety of references such as a message reception time, the number of unconfirmed messages, whether or not favorite setting on a counterpart, a name of the counterpart, a name of the chat room, and the number of events that a message is exchanged with a counterpart, and the like.

An example embodiment of inventive concepts is exemplified as notification information is displayed on the friend list screen 900. However, the scope and spirit of inventive concepts is not limited thereto. For example, the notification information may not be displayed, and a friend list including unconfirmed messages may be separately sorted and displayed through the “unconfirmed object sorting” menu 901 of the friend list screen 900-2.

In the friend list screen 900-2, also, a previous sorting reference may be again applied to friends, recognized as confirmation processing is performed with respect to unconfirmed messages, thereby making it possible to return the checked fried to original position of the whole friend list 910.

The above-described object sorting method may be applicable to all object lists, providing notification information, as well as the chat room list or the friend list of a messenger.

Based on a detailed description of an object sorting system given with reference to FIGS. 1 to 9, some operations of the object sorting method may be omitted, or some operations may be added to the object sorting method. In addition, two or more operations may be combined, and an order or positions of operations may be changed.

FIGS. 4 to 9 may be changed in a configuration or order of a screen as exemplary screens for the purpose of explanation and understanding according to inventive concepts.

FIG. 10 is a block diagram schematically illustrating an internal configuration of a computer system according to an example embodiment. As illustrated in FIG. 10, a computer system 1000 may include at least one processor 1010, a memory 1020, a peripheral interface 1030, an input/output subsystem 1040, a power circuit 1050, and a communication circuit 1060. Here, the computer system 1000 may be a user terminal.

The memory 1020 may include, for example, a high-speed random access memory (RAM), a magnetic disc, a static RAM (SRAM), a dynamic RAM (DRAM), a read only memory (ROM), a flash memory, or a nonvolatile memory. The memory 1020 may include a software module, a command set, or a variety of data necessary for an operation of the computer system. The processor 1020 may control an access to the memory 1020 from the processor 1010 or any other component (e.g., the peripheral interface 1030).

The peripheral interface 1030 may couple a peripheral input and/or output device of the computer system 1000 to the processor 1010 and the memory 1020. The processor 1010 may execute a software module, computer-readable instructions, and/or a command set, stored at the memory 1020 to perform a variety of functions for the computer system 1000, and to process data including the functionalities described above with reference to FIG. 1-9.

The input/output subsystem 1040 may couple a variety of peripheral input/output devices to the peripheral interface 1030. For example, the input/output subsystem 1040 may include a controller for coupling a monitor, a keyboard, a mouse, a printer, or a peripheral device such as a touch screen, or a sensor, to the peripheral interface 1030. According to another aspect, input/output peripheral devices may be coupled to the peripheral interface 1030 without passing through the input/output subsystem 1040.

All or a part of terminal components of a terminal may be may be powered by the power circuit 1050. For example, the power circuit 1050 may include a power management system, one or more power sources such as a battery or an alternating current (AC), a charging system, a power failure detection circuit, a power converter or inverter, a power status indicator, or any other components for power generation, management, and distribution.

The communication circuit 1060 may communicate with other computer system using at least one external port. As described above, the communication circuit 1060 may include an RF circuit and may communicate with other computer system by transmitting and receiving an RF signal known as an electromagnetic signal.

The computer system 1000 illustrated in FIG. 10 is one example configuration that a computer system may have. The computer system 1000 may not include some of components illustrated in FIG. 10, or may further include components not illustrated in FIG. 10, or may be implemented such that two or more components are combined. For example, the computer system 1000 for a mobile terminal of a communication environment may include a touch screen, a sensor and the like as well as components illustrated in FIG. 10, and the communication 1060 may include circuits for RF communications such as wireless-fidelity (Wi-Fi), 3G, long term evolution (LTE), Bluetooth, near field communication (NFC), Zigbee and the like. Components capable of being included in the computer system 1000 may be implemented with hardware, including an integrated circuit specialized for one or more signal processing or an application, software, an application or a combination thereof.

As such, according to example embodiments of inventive concepts, an unconfirmed state of an object may be easily checked and managed by providing a special sorting function on an unconfirmed object of objects displayed in operating an application. Thus, according to embodiments of the inventive concept, a practical sorting/rearranging function may be provided by maintaining a previous sorting/rearranging reference in the case of performing confirmation processing on an unconfirmed object or again driving an application after rearranging/sorting unconfirmed objects through a control of a user. In addition, according to embodiments of the inventive concept, confirmation processing on an unconfirmed object(s) of a list may be possible without executing of the unconfirmed object(s), thereby making it possible to process an unnecessary object(s) easily. This may means that it is easy to manage object.

Methods according to an example embodiment of inventive concepts may be implemented in the format of program instruction executable through various computer systems/processors and may be stored at a computer-readable medium.

In particular, a program (computer-readable program) according to an example embodiment of the inventive concept may be a PC-based program or an application dedicated to a mobile terminal. Accordingly, an application related to payment service may be implemented in a program form that operates independently or an in-app form (e.g., a portal service app, a search service app) of a particular application. It may be implemented to allow an operation on the particular application.

In addition, according to an example embodiment of inventive concepts, an application associated with a server system for providing a payment service may be performed by controlling the user terminal. For example, this application may execute one or more processors configured to perform one or more aspects of the features described herein. In addition, a messenger application to which the inventive concept is applied may be installed on a user terminal through a file which a file distribution system provides. For example, the file distribution system may include a file transfer unit (not illustrated) which transfers the file in response to a request of a user terminal.

The units (or devices) described herein may be implemented using hardware components, at least one processor executing software components, and/or a combination thereof. For example, devices and components described therein may be implemented by processing circuitry such as a processor, a controller, an arithmetic logic unit (ALU), a digital signal processor, a microcomputer, a field programmable gate array (FPGA), a programmable logic unit, a microprocessor or any other device capable of responding to and executing instructions in a defined manner. A processing device may run an operating system (OS) and one or more software applications that run on the OS. The processing device also may access, store, manipulate, process, and create data in response to execution of the software. For the sake of easy understanding, an embodiment of the inventive concept is exemplified as one processing device is used; however, one skilled in the art will appreciate that a processing device may include multiple processing elements and multiple types of processing elements. For example, a processing device may include multiple processors or a processor and a controller. In addition, other processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to embodiments may be implemented in the format of program instruction executable through various processing circuitry and may be recorded in a computer-readable medium. The computer-readable medium may also include program instructions, data files, data structures, and the like independently or in the format of combination. The program instructions recorded in the medium may be those specially designed and constructed for the embodiment or may be well-known and available to those skilled in the computer software arts. Examples of the computer-readable medium may include magnetic media such as hard disks, floppy disks, and magnetic tape; optical media such as CD ROM disks and DVD; magneto-optical media such as floptical disks; and hardware devices that are specialized to store and perform program instructions, such as read-only memory (ROM), random access memory (RAM), flash memory, and the like. Examples of program instructions may include both machine code produced by a compiler and high-level code executed by the computer using an interpreter. The described hardware devices may be configured as one or more modules or units to perform the operations of the above-described example embodiments, and vice versa.

Although being described with reference to specific examples and drawings, modifications, additions and substitutions on embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Therefore, other implementations, other embodiments and equivalent things of claims may be within the scope of the claims to be described later.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An object sorting method implemented with a computer, comprising:
displaying, by a processor, a list in which a plurality of objects are sorted according to a sorting reference, while an application associated with the plurality of objects is in use;
identifying, by the processor, at least one unconfirmed object from among the plurality of objects, the at least one unconfirmed object including information unconfirmed by a user of the application;
first adjusting, by the processor, the list such that the at least one unconfirmed object is displayed at a top of the list;
recognizing, by the processor, confirmation of the at least one unconfirmed object based on a control signal; and
second adjusting, by the processor, the list based on the sorting reference after the at least one unconfirmed object is confirmed.

2. The object sorting method of claim 1, wherein each of the plurality of objects is associated with a target with which the user communicates via the application.

3. The object sorting method of claim 1, wherein
the application is an instant messenger application, and
each of the plurality of objects is associated with one or more of a plurality of targets, the instant messenger including a chat room list in which one or more of the plurality of targets with which the user communicates are listed.

4. The object sorting method of claim 3, wherein the identifying of the at least one unconfirmed object identifies one or more chat rooms of the chat room list having a message, unconfirmed by the user, from among messages received at the application, as the at least one unconfirmed object.

5. The object sorting method of claim 3, wherein the identifying of the at least one unconfirmed object identifies one or more chat rooms of the chat room list having a message, unconfirmed by a corresponding one of the plurality of targets, from among messages transmitted to the plurality of targets via the application, as the at least one unconfirmed object.

6. The object sorting method of claim 1, wherein when the identifying identifies at least two unconfirmed objects, the first adjusting the list comprises:
applying the sorting reference to the at least two unconfirmed objects at the top of the list to rearrange the at least two unconfirmed objects.

7. The object sorting method of claim 1, wherein when the identifying identifies at least two unconfirmed objects, the first adjusting the list comprises:
applying a reference different from the sorting reference to the at least two unconfirmed objects at the top of the list to rearrange the at least two unconfirmed objects.

8. The object sorting method of claim 3, wherein the first adjusting the list comprises:
rearranging the at least one unconfirmed object using one of a message reception/transmission time, a number of messages associated with each of the at least one unconfirmed object, a name of a chat room associated with the at least one unconfirmed object, a name of a target associated with the at least one unconfirmed object, whether or not the target belongs to a list of favorite targets in the application, and a number of times that a message is exchanged with the target in the at least one unconfirmed object.

9. The object sorting method of claim 1, wherein the recognizing the confirmation of the at least one unconfirmed object comprises:
recognizing that information associated with the at least one unconfirmed object is read, when the at least one unconfirmed object is executed on the application.

10. The object sorting method of claim 1, wherein the recognizing the confirmation of the at least one unconfirmed object comprises:
receiving the control signal, the control signal being a confirmation request signal for the at least one unconfirmed object.

11. A non-transitory computer-readable medium storing instructions, which when executed by a processor, cause the processor to provide an instant messaging service by:
displaying a list in which a plurality of objects are sorted according to a sorting reference, while an application associated with the plurality of objects is in use;
identifying at least one unconfirmed object from among the plurality of objects, the at least one unconfirmed object including information unconfirmed by a user of the application;
first adjusting the list such that the at least one unconfirmed object is displayed at a top of the list;
recognizing confirmation of the at least one unconfirmed object based on a control signal; and
second adjusting the list based on the sorting reference after the at least one unconfirmed object is confirmed.

12. An object sorting system comprising:
a processor configured to execute computer-readable instructions to,
display a list in which a plurality of objects are sorted according to a sorting reference, while an application associated with the plurality of objects is in use;
identify at least one unconfirmed object from among the plurality of objects, the at least one unconfirmed object including information unconfirmed by a user of the application;
first adjust the list such that the at least one unconfirmed object is displayed at a top of the list;
recognize confirmation of the at least one unconfirmed object based on a control signal; and
second adjust the list based on the sorting reference after the at least one unconfirmed object is confirmed.

13. The object sorting system of claim 12, wherein each of the plurality of objects is associated with a target with which the user communicates via the application.

14. The object sorting system of claim 12, wherein
the application is an instant messenger application, and
each of the plurality of objects is associated with one or more of a plurality of targets, the instant messenger including a chat room list in which one or more of the plurality of targets with which the user communicates are listed.

15. The object sorting system of claim 14, wherein the processor is configured to identify the at least one unconfirmed object by:
identifying one or more chat rooms of the chat room list having a message, unconfirmed by the user, from among messages received at the application, as the at least one unconfirmed object.

16. The object sorting system of claim 14, wherein the processor is configured to identify the at least one unconfirmed object by:
identifying one or more chat rooms of the chat room list having a message, unconfirmed by a corresponding one of the plurality of targets, from among messages transmitted to the plurality of targets via the application, as the at least one unconfirmed object.

17. The object sorting system of claim 12, wherein when the processor identifies at least two unconfirmed objects, the processor is configured to first adjust the list by:
applying the sorting reference to the at least two unconfirmed objects at the top of the list to rearrange the at least two unconfirmed objects.

18. The object sorting system of claim 12, wherein when the processor identifies at least two unconfirmed objects, the processor is configured to first adjust the list by:
applying a reference different from the sorting reference to the at least two unconfirmed objects at the top of the list to rearrange the at least two unconfirmed objects.

19. The object sorting system of claim 12, wherein the processor is configured to recognize the confirmation of the at least one unconfirmed object by:
recognizing that information associated with the at least one unconfirmed object is confirmed, when the at least one unconfirmed object is executed on the application.

20. The object sorting system of claim 12, wherein the processor is configured to recognize the confirmation of the at least one unconfirmed object by:
receiving the control signal, the control signal being a confirmation request signal for the at least one unconfirmed object.
